(19) United States
(12) Patent Application Publication
(10) Pub. No.: US 2017/0023212 A1
(43) Pub. Date: Jan. 26, 2017

(54) LAMP

(71) Applicant: FunnyFish Inc., Seoul (KR)

(72) Inventor: Ji-Young Kim, Seoul (KR)

(21) Appl. No.: 14/995,733

(22) Filed: Jan. 14, 2016

(30) Foreign Application Priority Data
Jul. 24, 2015 (KR) 20-2015-0005005

(51) Int. Cl. F21V 17/00; F21V 1/18

(52) U.S. Cl. CPC F21V 17/002; F21V 1/18

(57) ABSTRACT

A lamp is disclosed. The lamp of this invention comprises a bulb supporter; at least one lampshade acceptor coupled to said bulb supporter, a plurality of accepting slits being formed in said at least one lampshade acceptor; and a plurality of lampshades to be inserted into the lampshade acceptor slits. At least one lampshade slits is formed in respective lampshades and the both sides of the lampshade silt are coupled together so as for the lampshade to have a three-dimensional shape. The lampshade may be made of “HANJI”, or Korean traditional paper.

### CROSS-REFERENCE TO RELATED APPLICATIONS

This application claims the benefit of Korean Utility Model Application No. 20-2015-0005005 filed with the Korean Intellectual Property Office on Jul. 24, 2015, the entire disclosure of which is incorporated herein by reference.

### BACKGROUND

1. Technical Field

The present invention relates to a lamp.

2. Description of the Related Art

A lamp is generally used as a local lighting or a moving lighting and is for illumination as well as ornamental feature. Also, when a lamp bulb is turned on, it is preferable that the light emitted from the bulb does not illuminate directly to a user but goes through a lampshade to a user, so as to reduce the fatigue of the user's eye. For this, the lampshade is generally made of a material such as cloth considering the light-transparency.

On the other hand, various shapes have been proposed for the decorative feature of lamp. Among them there are a flower-shaped lamp and a cone-shaped lamp, the lampshade of which are composed of a plurality of pieces. In the conventional lamp having a plurality of piece-lampshades, the lampshade is made of a material such as PVC for the sake of convenience of assembly and fixation of shape. In such case, the light from the bulb is passed through or reflected from PVC material, which causes disadvantageously to glare.

The related arts of the present invention are disclosed in Korean Patent 10-1526922 “Lighting Apparatus”, in U.S. Pat. No. 6,200,008 “Spring clip light fixture connector”, and in European Patent EP 0175334 B1 “Lighting fixture”.

### SUMMARY OF THE INVENTION

Thus, the present invention is provided with a lamp which can reduce the possibility for the light from bulb to directly touch user's eyes and keeps the transmittance of light in proper level.

To solve the above-mentioned problem, according to one embodiment of this invention, there is provided with a lamp comprising: a bulb supporter capable of accepting a bulb; at least one lampshade acceptor coupled to said bulb supporter, wherein a plurality of accepting slits are formed in said at least one lampshade acceptor; and a plurality of lampshades to be inserted to the lampshade acceptor, wherein at least one lampshade slit is formed in each of said plurality of lampshades and a pair of connector accepting hole are formed in either side of said at least one lampshade, and wherein a three-dimensional curve surface could be made by coupling the pair of connector accepting holes with each other in each of said plurality of lampshades.

According to the embodiments of this invention, the lampshades can be made of “HANJI”, or Korean traditional paper. The lamp may further comprise a connector for coupling said pair of connector accepting holes and the connector can be a button made of flexible PVC.

According to one embodiment of this invention, the bulb supporter includes three supporting legs which are capable of fit-together coupling, the upper part of the three supporting legs being substantially ∪-shape; wherein said at least one lampshade acceptor includes an upper lampshade acceptor and a lower lampshade acceptor; and wherein six leg accepting holes are formed in said lower lampshade acceptor for accepting the upper part of the supporting leg. The bulb supporter may further comprise a distance regulator which spaces the upper lampshade acceptor and the lower lampshade acceptor a predetermined interval apart; and wherein bulb accepting holes are formed in the upper lampshade acceptor and the lower lampshade acceptor.

According to another embodiment of this invention, the bulb supporter may comprise three supporting legs which are coupled by fit-joint, the upper part of each supporting leg being shaped substantially “∪”; and wherein the at least one lampshade acceptor is coupled to the upper part of the supporting legs by screw.

According to another embodiment of this invention, the bulb supporter may have the structure capable of being fixed to a wall.

According to another embodiment of this invention, a center lampshade slit can be formed in respective lampshades; or in each of said plurality of lampshades, the opposite side of the lampshade slit is concave shape and a pair of connector accepting holes are formed at either side of the concave part, which are coupled to each other so as to form another three-dimensional curve. In another embodiment, decorative character(s) may be formed in the opposite side to the lampshade slit.

According to another embodiment of this invention, there is provided with a lamp comprising: a bulb supporter; at least one lampshade acceptor coupled to said bulb supporter, a plurality of accepting slits being formed in said at least one lampshade acceptor; and a plurality of lampshades to be inserted into the lampshade acceptor slits, wherein at least one lampshade slits is formed in each of said lampshades and the both sides of the lampshade silt are coupled together so as for the lampshade to have a three-dimensional shape. The lampshade can be made of “HANJI”, or Korean traditional paper.

According to one embodiment of this invention, the possibility that the light emitted from the bulb touches the user directly, can be reduced so as to improve the feeling of the lamp in usage. The lamp according to one embodiment of this invention can give the pleasure of DIY assembly to a user and there is advantage that the repair of piece-lampshade is very easy when the lampshade is damaged especially in part.

Though a various effect according to the embodiments of this invention is not directly mentioned, it is apparent that the combination of the components of the embodiments could be understand and utilized to those skilled in this art.

### BRIEF DESCRIPTION OF THE DRAWINGS

The patent or application file contains at least one color photograph. Copies of this patent or patent application publication with color photograph(s) will be provided by the Office upon request and payment of the necessary fee.

FIG. 1A is a photograph of a lamp, according to one embodiment of this invention;

FIG. 1B is a photograph of a lamp, according to one embodiment of this invention;

FIG. 1C is a photograph of a lamp, according to one embodiment of this invention;

FIG. 2A is a photograph of a lamp, according to another embodiment of this invention;

FIG. 2B is a photograph of a lamp, according to another embodiment of this invention;

FIG. 3 is a photograph of a lamp, according to another embodiment of this invention;

FIG. 4 shows an internal structure of lamps shown in FIGS. 1A, 1B and 1C, in which the lampshades are removed;

FIG. 5A is a drawing illustrating the exploded view of the supporting legs 103 of FIG. 4;

FIG. 5B is a drawing illustrating the exploded view of the supporting legs 103 of FIG. 4;

FIG. 5C is a drawing illustrating the exploded view of the supporting legs 103 of FIG. 4;

FIG. 5D is a drawing illustrating the lower lampshade acceptor 403 shown in FIG. 4;

FIG. 5E is a drawing illustrating the upper lampshade acceptor 401 shown in FIG. 4;

FIG. 5F is a drawing illustrating a distance regulator 405 shown in FIG. 4;

FIG. 6 is a photograph illustrating the internal structure of lamps shown in FIGS. 2A and 2B, in which the lampshades are removed;

FIG. 7A is a drawing illustrating the exploded view of the supporting legs 203 shown in FIG. 6;

FIG. 7B is a drawing illustrating the exploded view of the supporting legs 203 shown in FIG. 6;

FIG. 7C is a drawing illustrating the exploded view of the supporting legs 203 shown in FIG. 6;

FIG. 7D is a drawing illustrating one example of the lampshade acceptor 603 shown in FIG. 6;

FIG. 7E is a drawing illustrating the bulb supporter shown in FIG. 6;

FIG. 7F is a drawing illustrating the combiner shown in FIG. 6;

FIG. 8 is a photograph illustrating the internal structure of lamps shown in FIG. 3, in which the lampshades are removed;

FIG. 9A is a drawing illustrating a lampshade according to one embodiment of this invention;

FIG. 9B is a photograph illustrating that the lampshade shown in FIG. 9A is deformed by combiner;

FIG. 9C are drawings comprising plan and elevational views of a female and male buttons of a combiner, respectively, according to one embodiment of this invention;

FIG. 10A is a drawing illustrating a lampshade according to another embodiment of this invention;

FIG. 10B is a photograph illustrating that the lampshade shown in FIG. 10A is deformed by combiner;

FIG. 11A is a drawing illustrating a lampshade according to another embodiment of this invention;

FIG. 11B is a photograph illustrating that the lampshade shown in FIG. 11A is deformed by combiner;

FIG. 12A is a drawing illustrating a lampshade according to another embodiment of this invention;

FIG. 12B is a photograph illustrating that the lampshade shown in FIG. 12A is deformed by combiner;

FIG. 13A is a drawing illustrating a lampshade according to another embodiment of this invention;

FIG. 13B is a photograph illustrating that the lampshade shown in FIG. 13A is deformed by combiner;

FIG. 14A is a photograph illustrating a lampshade according to another embodiment of this invention;

FIG. 14B is a photograph illustrating that the lampshade shown in FIG. 14A is deformed by combiner;

FIG. 15 is a photograph for explaining that the lampshade is inserted into the slit of the lampshade acceptor, according to one embodiment of this invention; and

FIG. 16 is a photograph illustrating a lamp according to another embodiment of this invention.

### DETAILED DESCRIPTION OF THIS INVENTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the ideas and scope of the present invention.

Hereinafter, in the explanation of the embodiments of this invention, when the gist of this invention would become unnecessarily unclear due to the detailed explanation of the related known function or art, the detailed explanation thereof will be omitted. Also, the single expression in the specification and the claims be generally interpreted as “one or more”, unless stated otherwise.

Hereinafter, with reference to the accompanying drawings, the embodiments of this invention will be explained in more detail.

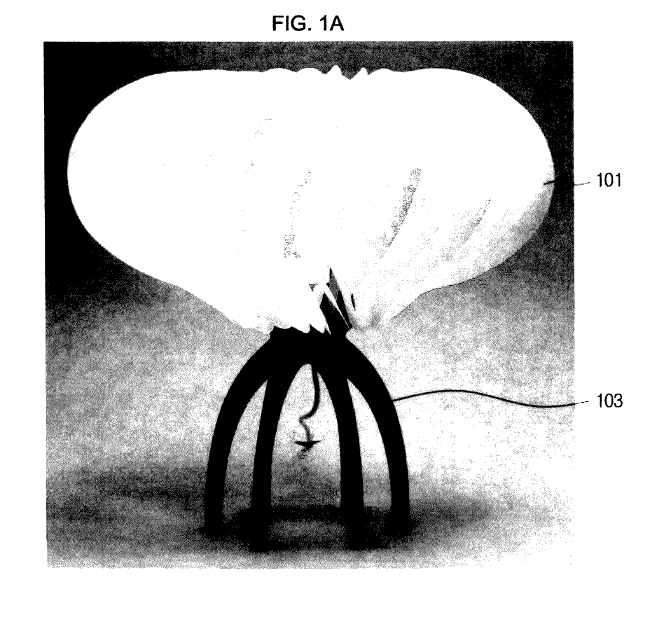

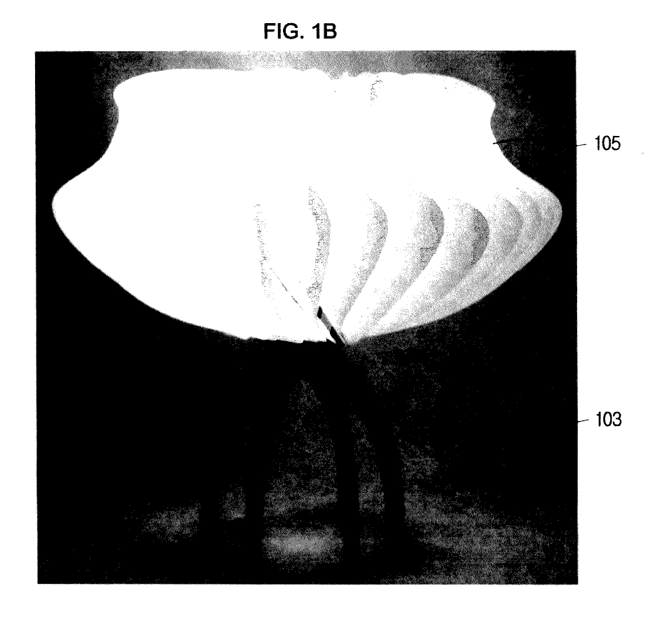

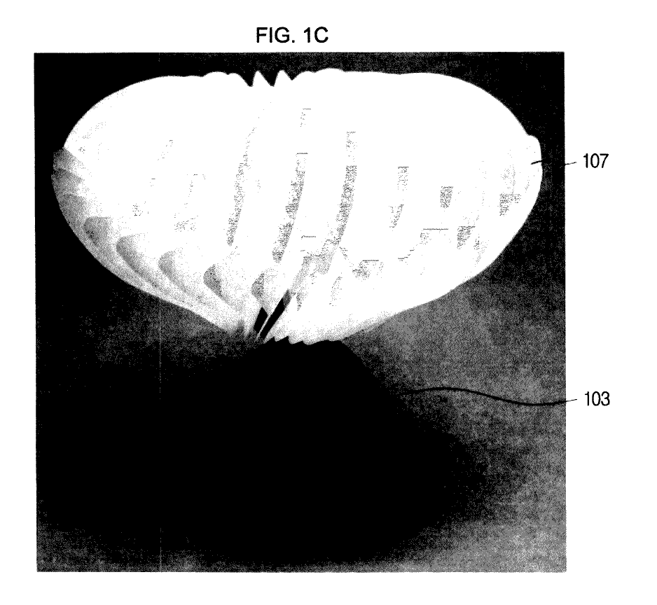

FIG. 1A to FIG. 1C show lamps according to one embodiment of this invention. Referring to FIG. 1A, the overall shape of the lamp according to one embodiment of this invention comprises supporting legs 103 in the lower part and a plurality of lampshades 101 in the upper part. The plurality of lampshades 101 form a three-dimensional curved surface, so that the light should not shine directly from light bulb such as electric light bulb located inside of the plurality of lampshade 101.

The plurality of lampshade 101 may be made of ‘HANJI’ (Korean traditional paper), so that the light from the internal bulb passes through ‘HANJI’ and softly shines outside which results in external decorative effect and effectively reducing the fatigue of the user's eye. Also the thickness of ‘HANJI’ is preferably 0.2 mm-0.4 mm so that the shape of ‘HANJI’ should be kept for a long period of time and ‘HANJI’ should transmit the light from the bulb to outside. If the ‘HANJI’ lampshade may be sprayed with Spray perfume or aromatherapy essences, it would have an advantage that the user can enjoy the light as well as the fragrance.

The lampshade 105 of lamp shown in FIG. 1B and the lampshade 107 of lamp shown in FIG. 1C, as shown in figures, form a three-dimensional curved surface, so that the light from the inside electric light bulb would not directly shine outside but through the lampshades.

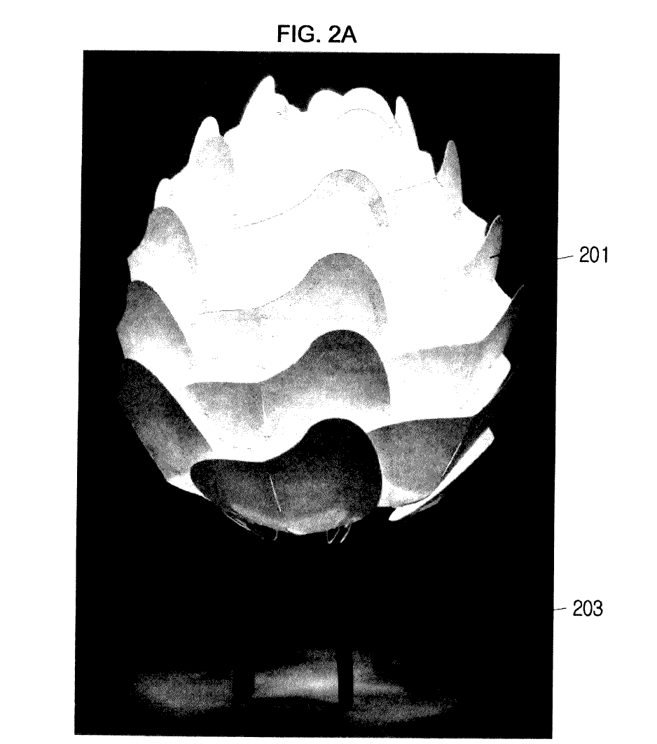

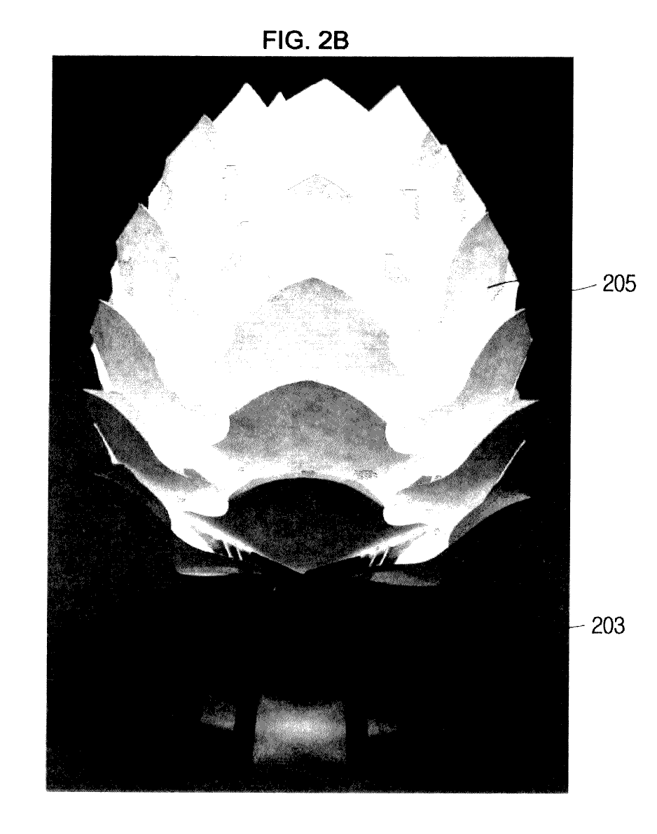

FIG. 2A and FIG. 2B show the lamps according to another embodiments of the present invention. Referring to FIG. 2A and FIG. 2B, there appears to the outside the supporting legs 203 in the lower part and a plurality of lampshades 201, 205 in the upper part. The lampshades 101, 105 and 107 in FIG. 1A through FIG. 1C are arranged in the longitudinal direction, while the lampshades 201 and 205 in FIG. 2A and FIG. 2B are arranged in the horizontal direction.

Also, the lampshades 201 and 205 in FIG. 2A and FIG. 2B (201, 205) form three-dimensional curved surface and are arranged to be partially overlapped each other, so that the light from the internal light is not irradiated directly to the outside but through the lampshades indirectly to the outside. Thus, the light from the internal bulb passes through the lampshade made of ‘HANJI’ so as to be transformed softly.

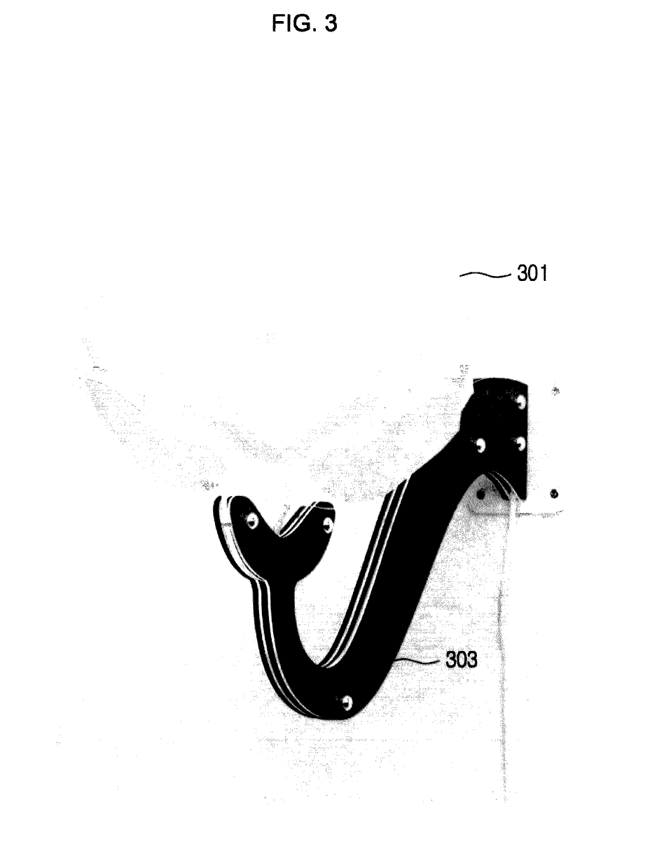

FIG. 3 shows a lamp according to another embodiment of the present invention. Referring to FIG. 3, there appear a plurality of lampshades 301 and a wall-fixer 303 to be outside.

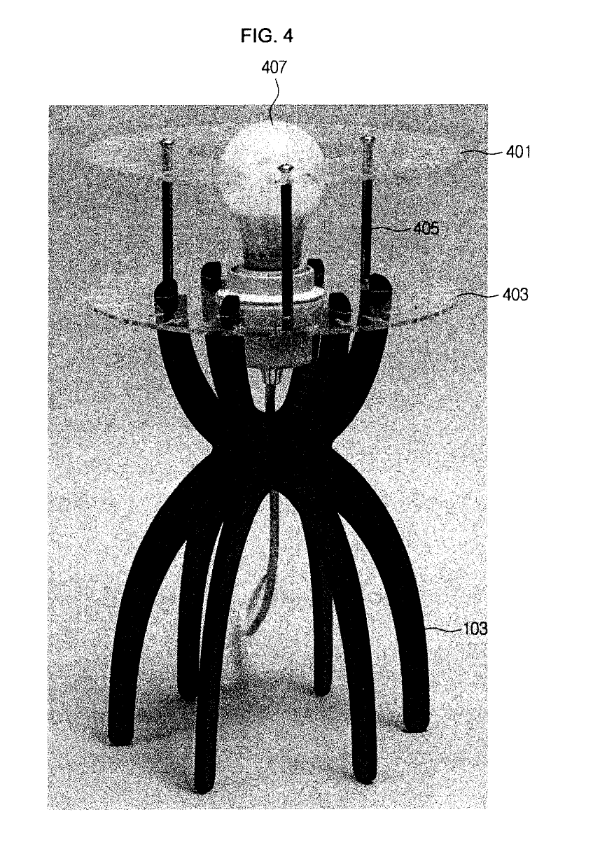

FIG. 4 shows an internal structure of the lamps shown in FIG. 1A to FIG. 1C, in which the lampshades are removed. Referring to FIG. 4, the internal structure of lamp includes supporting legs 103, an upper lampshade acceptor 401, a lower lampshade acceptor 403, a distance regulator 405 and an electric bulb 407. Here, the electric bulb 407 may be removable.

FIG. 5A to FIG. 5C illustrate the exploded view of the supporting legs 103 shown in FIG. 4. Referring to FIG. 5A through FIG. 5C, the upper part 103b of the supporting legs 103 are substantially formed in the “∪” shape and the lower part 103a of the supporting legs 103 are substantially formed in the “∩” shape. In the middle part of the supporting legs 103, three kinds of grooves are formed for the fit-joint, or fit-together coupling between each another.

The length of lower groove of FIG. 5A is about ‘h2+h3’, the length of upper groove of FIG. 5b is about ‘h1’, the length of lower groove of FIG. 5B is about ‘h3’, the distance between the upper groove and the lower groove of FIG. 5B is about ‘h2’, and the length of upper groove of FIG. 5C is about ‘h1+h2’. Also, in the upper end 103c of the supporting legs 103 the curved surface is formed in the outer and a step is formed in the inner. That is, in FIG. 5, there is a relationship of ‘h5>h4’.

FIG. 5D shows the lower lampshade acceptor 403 shown in FIG. 4. Referring to FIG. 5D, six leg acceptors 501, a plurality of accepting slits 503, a plurality of distance regulator holes 504a, 504b and 504c, and a lower bulb accepting hole 505 are formed in the lower lampshade acceptor 403.

According to the embodiment, the lower lampshade acceptor 403 may be made of transparent plastic. According to the embodiment, the length of leg acceptor 501 is longer than ‘h4’ and shorter than ‘h5’ of FIG. 5A, so that the lower lampshade acceptor 403 can be stably inserted into the step portion of the supporting legs 103.

Also, the six leg acceptors 501 may be evenly arranged in circular so as to guide the supporting leg combined in stable structure. In the middle part of accepting slit 503, connecting member accepting grooves 503a is formed.

FIG. 5E shows the upper lampshade acceptor 401 shown in FIG. 4. Referring to FIG. 5e, a plurality of accepting slits 507, a plurality of distance regulator holes 510a, 501b and 501c, and an upper bulb accepting hole 509 in the upper lampshade acceptor 401 and a combiner accepting groove 507a is formed in the middle part of the accepting slit.

The diameter of the upper bulb accepting hole 509 may be larger than the diameter of the lower bulb accepting hole 505. This is for accepting the general purpose commercially sold electric bulb, so that it can be modified in accordance with the shape of bulb.

FIG. 5F shows the distance regulator 405 shown in FIG. 4. Referring to FIG. 5F, the distance regulator 405 is composed of three double-ended-exterior screws 511a, 511b and 511c, and six interior screws 512a, 512b, 512c, 512d, 512e and 512f. Using exterior screw and two interior screws the holes 510a, 510b and 501c in the upper lampshade acceptor and the holes 504a, 504b and 504c in the lower lampshade acceptor are combined respectively with a predetermined distance. Here, the upper lampshade acceptor 401 and the lower lampshade acceptor 403 are separated from each other with the length of exterior screw of the distance regulator.

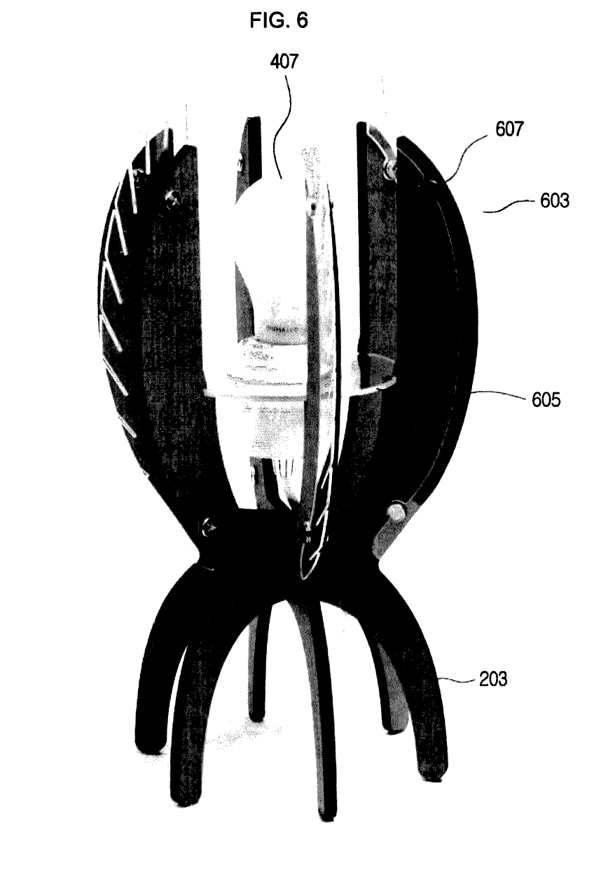

FIG. 6 shows the internal structure of lamps shown in FIG. 2A and FIG. 2B, in which the lampshades are moved out. Referring to FIG. 6, the internal structure of lamp includes supporting legs 203, lampshade acceptors 603, a bulb supporter 605 and a bulb 407.

Here, the bulb 407 may be removable. The lampshade acceptors 603 are coupled respectively to the supporting legs 203 with the connecting members 607 and the bulb supporter 605 is located in the inner middle part of the supporting legs 203.

FIG. 7A to FIG. 7C show the exploded view of the supporting legs 203 shown in FIG. 6. Referring to FIG. 7A through FIG. 7C, the upper part 203b of the supporting legs 203 are formed substantially in the shape of ‘∪’ and the lower part 203a are formed substantially in the shape of ‘∩’, and three kinds of grooves are formed in the middle part of the supporting legs for the sake of fit-joint.

The length of the lower groove of FIG. 7A is about ‘x2+x3’, the length of the upper groove and the lower groove in FIG. 7B are about ‘x1’ and about ‘x3’ respectively, the distance between the upper groove and the lower groove in FIG. 7B is about ‘x2’, and the length of the upper groove of FIG. 7C is about ‘x1+x2’. Steps are formed to safely fix the bulb supporter 605 in the upper inner part of the supporting legs 203. In more detail, the width ‘y1’ is bigger than the width ‘y2’ in FIG. 7A.

Also, holes 700a and 700b are formed in the upper branch of supporting legs for combining the lampshade acceptors 603.

FIG. 7D shows one example of the lampshade acceptor 603 of FIG. 6. Referring to FIG. 7D, a plurality of accepting slits 701 are formed and a plurality of connecting holes 703a and 703b are formed in the lampshade acceptors 603. The plurality of connecting holes 703a and 703b in the lampshade acceptor correspond to the holds 700a and 700b of the supporting legs 203 respectively.

FIG. 7E shows the bulb supporter shown in FIG. 6. Referring to FIG. 7E, in the bulb supporter 605, a bulb accepting hole 707 is formed in the middle part thereof with the shape of circle and six supporting leg accepting grooves 705 are formed in the outer part.

The supporting leg accepting grooves 705 are evenly arranged in the outer circle, so that the supporting legs to be fixed therein should be safely arranged. The distance ‘y3’ between the opposite supporting leg accepting grooves 705 is equal to or slightly less than ‘y1’ of FIG. 7A and is longer than ‘y2’ of FIG. 7A.

FIG. 7F shows the combiner shown in FIG. 6, in which the combiner 607 includes an interior screw 709b and an exterior screw 709a. The combiner fix the lampshade acceptor 603 to the upper part of the supporting legs 203 by screw-joint.

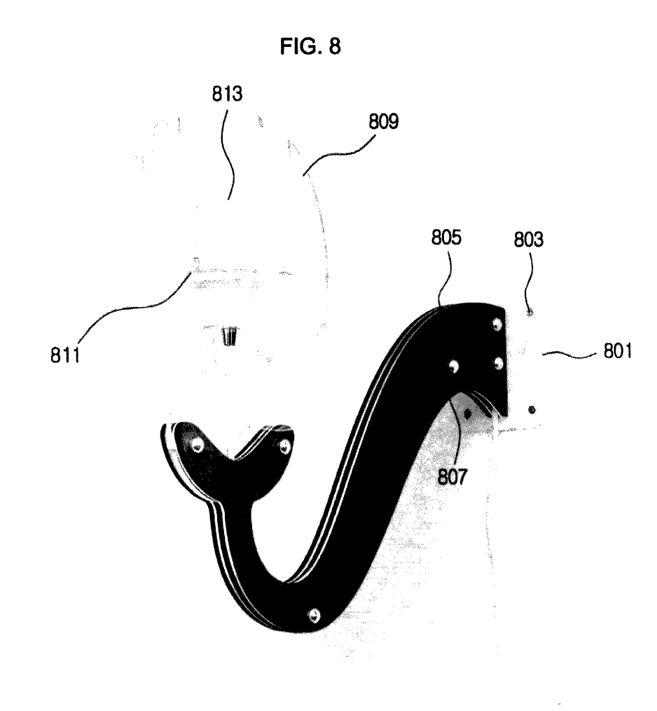

FIG. 8 shows the internal structure of lamps shown in FIG. 3, in which the lampshades are eliminated. Referring to FIG. 8, the internal structure includes a lamp supporter, lampshade acceptors 809, a bulb supporter 811 and a bulb 813, in which the bulb may be removable. Also, the lamp supporter includes a wall fix member 801 and a projecting supporter 805. The wall fix member 801 can be fixed to the wall to which the lamp is attached, with a fixing element such as nail.

The projecting supporter 805 can be formed with at least two panels coupled in screw-joint. The lampshade acceptors 809 can be supported by the projecting supporter 805. In the outer parts of the lampshade acceptors 809 a plurality of accepting slits are formed to accept the lampshades and the inner part of the lampshade acceptors 809 has a substantially vertical shape. Also, there are steps in the inner part of the lampshade acceptors 809 to accept the bulb supporter 811.

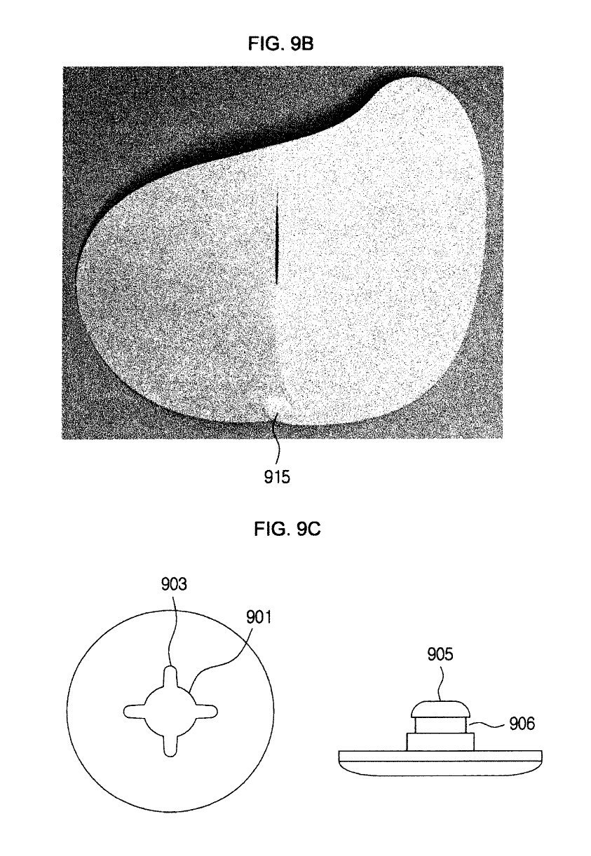

FIG. 9A shows a lampshade according to one embodiment of this invention. Referring to FIG. 9A, there are formed a lampshade slit 905 and a pair of connecting member accepting holes 903a and 903b in the lampshade 201.

Also, an incision 907 is formed in the middle part of the lampshade 201. The pair of connecting member accepting holes 903a and 903b are formed apart at a predetermined distance on either side of the lampshade slit 905. Here the longer the distance to be apart from the connecting member accepting holes 903a and 903b is, the bigger the three-dimensional effect when the connecting member accepting holes are combined is. FIG. 9B shows that the lampshade shown in FIG. 9A is deformed by combining with combiner 915.

FIG. 9C is one example of combiner which can be used for combining the connecting member accepting holes with each other in the lampshades according to embodiments of this invention. Referring FIG. 9C, a circular hole 901 is formed in the middle of female button and four grooves 903 are formed in the circular hole 901

Also a projection part 905 is formed in the male button and a niche part 906 is formed to accept the female button. The female button and the male button can be made of PVC and the diameter of circular hole 901 of female button is slightly less than the diameter of the projection part and is larger than the diameter of the niche part 906.

According to another embodiment of this invention, the connecting member accepting holes may be not formed. Instead, the points to be combined with each other can be noted, for example, by small dots, and then may be combined by stapler.

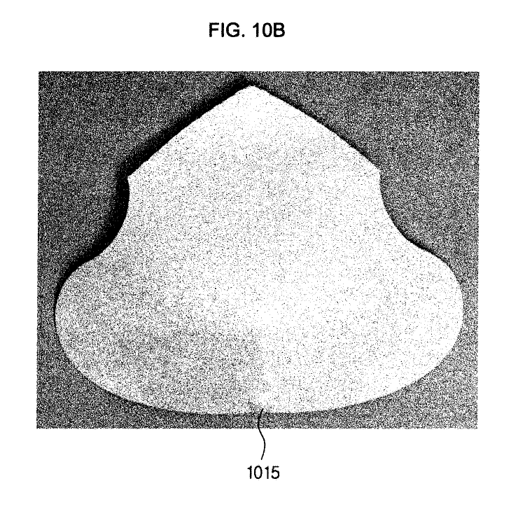

FIG. 10A shows a lampshade according to another embodiment of this invention. Referring to FIG. 10A, a lampshade slit 1005 and a pair of connecting member accepting holes 1003a and 1003b are formed in the lampshade.

Also the other side of the lampshade has a substantially curved ‘M’ shape, and there are formed a curved part 1009 and a pair of connecting member accepting holes 1007a and 1007b which are positioned at the either sides with the center of the curved part.

Here, the curved part functions as that of the lampshades. Thus when the combiner 1015 (the other combiner is not shown in the figure because it is located at the other side) shown in FIG. 10A are coupled to each other, two parts are deformed to have three-dimensional shape, as shown in FIG. 10B.

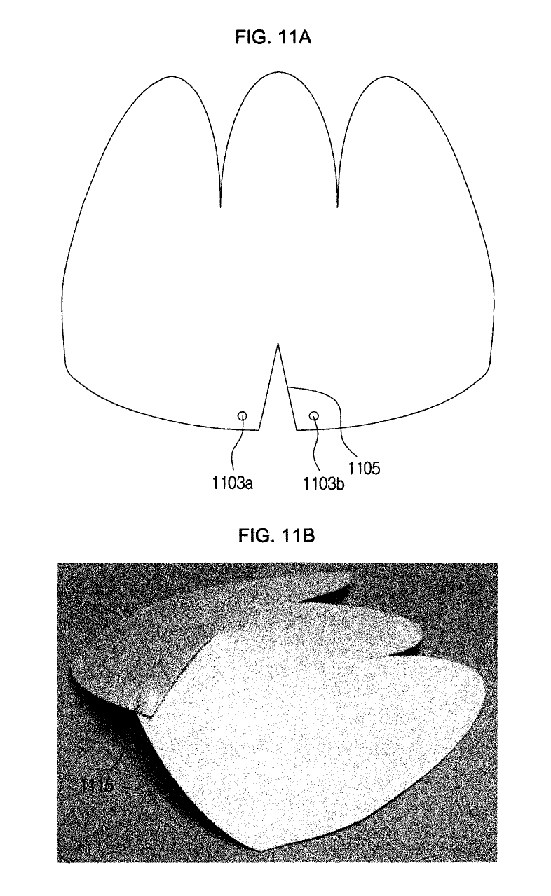

FIG. 11A shows a lampshade according to another embodiment of this invention and FIG. 11B shows the deformation of the lampshade shown in FIG. 11A which is made by connection with the combiner 1115. Referring to FIG. 11A, in the lampshade a lampshade slit 1105 and a pair of connecting member accepting holes 1103a and 1103b are formed, and a three-step curve shape is formed for decoration in the opposite side of the slit.

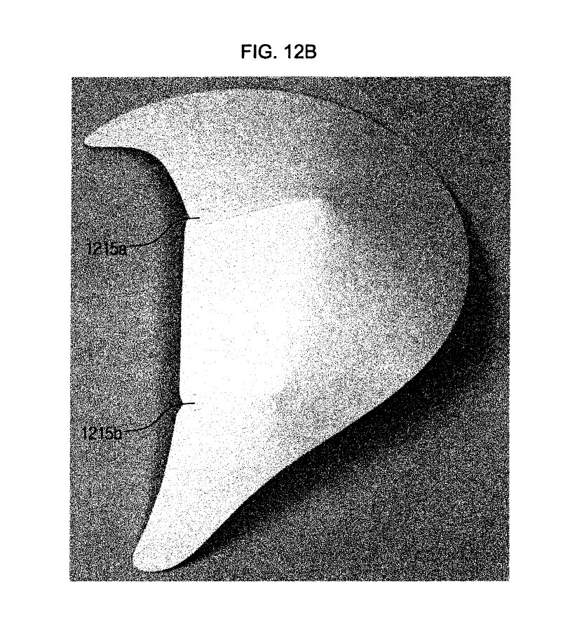

FIG. 12A shows a lampshade according to another embodiment of this invention and FIG. 12B shows the deformation of the lampshade shown in FIG. 12A which is made by coupling the combiners 1215a and 1215b.

Referring to FIG. 12A, two pair of connecting member accepting holes 1203a, 1203b, 1207a and 1207b are formed in the lampshade and the opposite side of the slit is formed with curve.

As shown in FIG. 12A there can be formed a plurality of slits and corresponding connecting member accepting holes, so that the part of lampshade slit should be deformed to three-dimensional shape. Thus, a various shape of lampshade can be obtained by forming a lampshade slit and corresponding pair of connecting member accepting holes at a specific position.

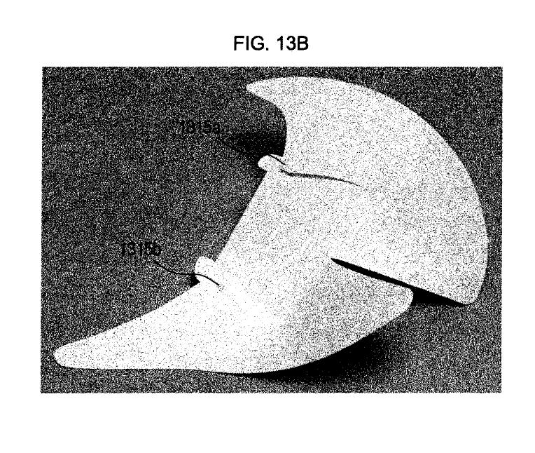

FIG. 13A shows a lampshade according to another embodiment of this invention and FIG. 13B shows the deformation of lampshade shown in FIG. 13A which is made by coupling the combiners 1315a and 1315b.

Referring to FIG. 13A, there are formed lampshade slits 1305 and 1309 and connecting member accepting holes 1303a, 1303b, 1307a and 1307b, and a slit 1311 is formed in the opposite side of the lampshade slits. The slit 1311 gives the freedom of wing's moving so as to increase the variety of decoration.

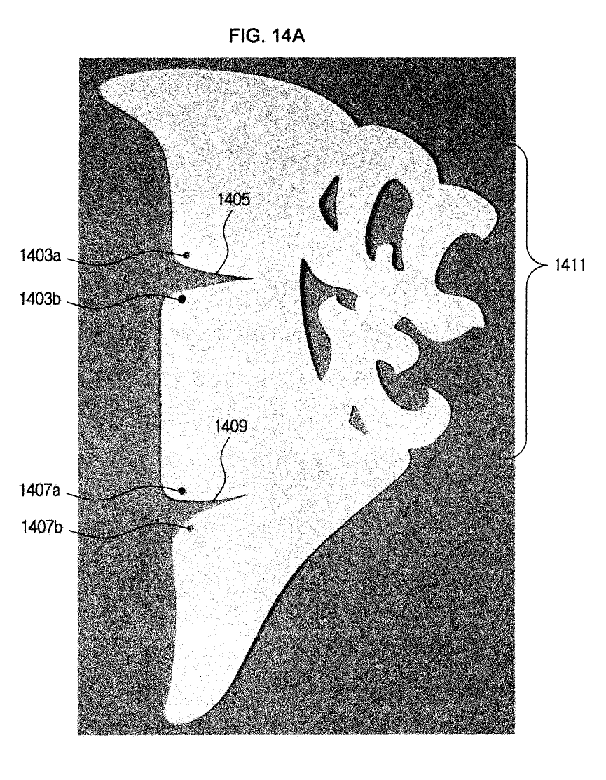

FIG. 14A shows a lampshade according to another embodiment of this invention, and FIG. 14B shows the deformation of the lampshade shown in FIG. 14A by combination of the combiners 1415a and 1415b.

Referring to FIG. 14A, lampshade slits 1205 and 1209 and two pair of connecting member accepting holes 1203a, 1203b, 1207a and 1207b are formed in the lampshade, and the opposite side of the slits has the shape of decorative character “ [symbol] ” which is a Korean character meaning “flower”.

Like this, the opposite side of the lampshade slits would be shown outside of lamp, so that something decorative could be formed at the opposite side of the lampshade slits. In addition to the decorative characters, various modification may be possible. For example, different kind material member(s) may be attached and/or decorative material(s) may be attached to the opposite side of the lampshade slits.

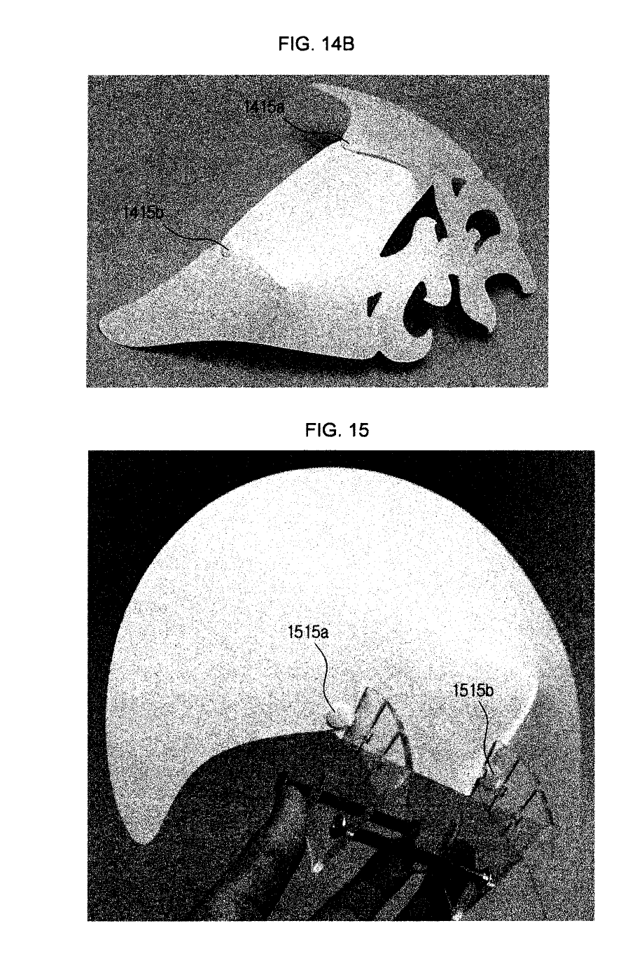

FIG. 15 is for illustrating that the lampshade is inserted into the lampshade acceptor, according to one embodiment of this invention. As shown in FIG. 15, the lampshade made of ‘HANJI’ is inserted into the accepting slit of the lampshade acceptor and the combiner 1515a and 1515b, for example buttons, is safely accepted into the groove of the accepting slit, so that the power of fixation of the lampshade would be increased.

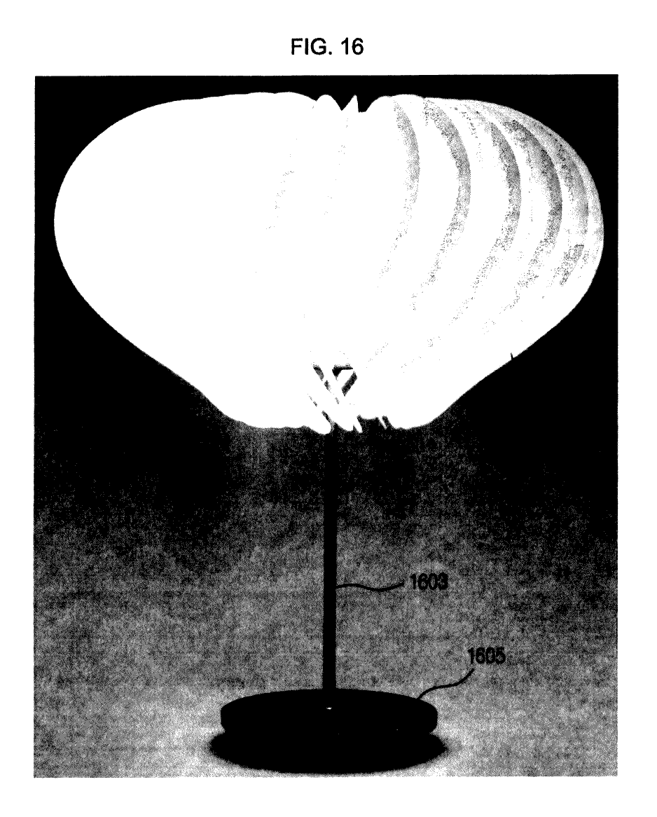

FIG. 16 shows a lamp according to another embodiment of this invention. Referring to FIG. 16, the bulb supporter of lamp is formed in the shade of vertical supporting leg 1603 which stands on the base 1605. The lampshade acceptor is mounted in the upper part of the vertical supporting leg 1603 and a plurality of lampshades 1601 may be inserted into the lampshade acceptor.

As described above, the lampshades according to the embodiments of this invention may be easily removable and can be easy for archive. Also, a variety of patterns and messages can be printed in the lampshade, which can be made in a variety of forms. Accordingly, as needed, only exchange of lampshades would create new feeling of the lamp.

The above described embodiments and the accompanying drawings are not limited to the scope of this invention but exemplary for the sake of the understanding of this invention of the person skilled in this art. Also, the embodiments according to the various combination of the above described composition may be obviously implemented by the person skilled in this art from the above detailed explanation.

Thus, the various embodiments of this invention can be implemented by the modification within the scope of essential feature of this invention, and the scope of this invention should be interpreted in accordance with the claims and includes various modifications, alternatives, and equivalents by the person skilled in this art.

1. A lamp comprising:
a bulb supporter capable of accepting a bulb;
at least one lampshade acceptor coupled to said bulb supporter, wherein a plurality of accepting slits are formed in said at least one lampshade acceptor; and
a plurality of lampshades to be inserted to the lampshade acceptor,
wherein at least one lampshade slit is formed in each of said plurality of lampshades and a pair of connector accepting holes are formed in either side of said at least one lampshade, and
wherein a three-dimensional curved surface could be made by coupling the pair of connector accepting holes with each other in each of said plurality of lampshades.

2. The lamp according to claim 1,
wherein said plurality of lampshades are made of “HANJI”, or Korean traditional paper.

3. The lamp according to claim 1, further comprising a connector for coupling said pair of connector accepting holes.

4. The lamp according to claim 3,
wherein said connector is a button made of flexible PVC.

5. The lamp according to claim 4,
wherein said plurality of lampshades are made of “HANJI”, or Korean traditional paper.

6. The lamp according to claim 1,
wherein said bulb supporter includes three supporting legs which are capable of fit-together coupling, each of the upper part of the three supporting legs being substantially ∪-shape;
wherein said at least one lampshade acceptor includes an upper lampshade acceptor and a lower lampshade acceptor; and
wherein six leg accepting holes are formed in said lower lampshade acceptor for accepting the upper part of the supporting leg.

7. The lamp according to claim 6,
wherein said bulb supporter further comprises a distance regulator which spaces the upper lampshade acceptor and the lower lampshade acceptor a predetermined interval apart; and
wherein bulb accepting holes are formed in the upper lampshade acceptor and the lower lampshade acceptor.

8. The lamp according to claim 7,
wherein said plurality of lampshades are made of “HANJI”, or Korean traditional paper.

9. The lamp according to claim 1,
wherein said bulb supporter includes three supporting legs which are coupled by fit-joint, the upper part of each supporting leg being shaped substantially “∪”; and
wherein said at least one lampshade acceptor is coupled to the upper part of the supporting legs by screw.

10. The lamp according to claim 9,
wherein said plurality of lampshades are made of “HANJI”, or Korean traditional paper.

11. The lamp according to claim 1,
wherein said bulb supporter has the shape to be fixed to a wall.

12. The lamp according to claim 11,
wherein said plurality of lampshades are made of “HANJI”, or Korean traditional paper.

13. The lamp according to claim 1, wherein a center lampshade slit is formed in each of said plurality of lampshades.

14. The lamp according to claim 13,
wherein said plurality of lampshades are made of “HANJI”, or Korean traditional paper.

15. The lamp according to claim 2,
wherein, in each of said plurality of lampshades, the opposite side of the lampshade slit is concave shape and a pair of connector accepting holes are formed at either side of the concave part.

16. The lamp according to claim 1,
wherein, in each of said plurality of lampshades, a decorative character is formed in the opposite side to the lampshade slit.

17. The lamp according to claim 16,
wherein said plurality of lampshades are made of “HANJI”, or Korean traditional paper.

18. A lamp comprising:
a bulb supporter;
at least one lampshade acceptor coupled to said bulb supporter, a plurality of accepting slits being formed in said at least one lampshade acceptor; and
a plurality of lampshades to be inserted into the lampshade acceptor slits,
wherein at least one lampshade slits is formed in each of said lampshades and the both sides of the lampshade silt are coupled together so as for the lampshade to have a three-dimensional shape.

19. The lamp according to claim 18,
wherein said plurality of lampshades are made of “HANJI”, or Korean traditional paper.

20. The lamp according to claim 19,
wherein said bulb supporter includes three supporting legs which are capable of fit-together coupling, the upper part of the three supporting legs being substantially ∪-shape;
wherein said at least one lampshade acceptor includes an upper lampshade acceptor and a lower lampshade acceptor; and
wherein six leg accepting holes are formed in said lower lampshade acceptor for accepting the upper part of the supporting leg.
